(19) United States
(12) Patent Application Publication
(10) Pub. No.: US 2012/0101606 A1
(43) Pub. Date: Apr. 26, 2012

(54) INFORMATION PROCESSING APPARATUS, CONTENT DATA RECONFIGURING METHOD AND PROGRAM

(76) Inventor: Yasushi MIYAJIMA, Kanagawa (JP)

(21) Appl. No.: 13/275,586

(22) Filed: Oct. 18, 2011

(30) Foreign Application Priority Data
Oct. 22, 2010 (JP) P2010-236971

(51) Int. Cl. G06F 17/00

(52) U.S. Cl. 700/94

(57) ABSTRACT

An apparatus for processing content data may include a score calculation unit. The score calculation unit may be configured to receive attribute information indicative of attributes of first content data. Additionally, the score calculation unit may be configured to calculate scores of temporal sections of the first content data, based on temporal positions within the first content data at which the attributes of the first content data change. The apparatus may also include a reconfiguration unit. The reconfiguration unit may be configured to receive the first content data. In addition, the reconfiguration unit may be configured to extract selected ones of the temporal sections from the first content data, based on the scores of the temporal sections. The reconfiguration unit may also be configured to combine the extracted temporal sections to create modified content data.

### CROSS-REFERENCE TO RELATED APPLICATION

This application claims priority of Japanese Patent Application No. 2010-236971, filed on Oct. 22, 2010, the entire content of which is hereby incorporated by reference.

### BACKGROUND

The present disclosure relates to an information processing apparatus, a content data reconfiguring method, and a program.

For example, in a content distribution service, such as a music distribution service, a trial listening version different from a finally sold version is provided to a user in order to assist the user to decide purchase of content, such as music. Generally the trial listening version is produced while a reproduction time of the music is shortened by cutting out part of the music. The user easily understands contents of the music in a short time by reproducing the trial listening version, which allows the user to decide whether the music meets preference of the user.

In a service model called subscription, for example, the user who pays a flat-rate monthly usage fee can freely down-load a large amount of music data provided by the service. In this case, although the user can purchase a large amount of music, it is not easy for the user to find the music that meets preference of the user from the large amount of purchased music. Unless the trial listening version in which the reproduction time is shortened is provided, in order to select the music that meets preference of the user, the user interminably reproduce the large amount of music to spend an immense amount of time.

Some users who want to briefly understand contents of the music while already purchasing the whole of the music manually performs digest reproduction by repeating fast-forward and reproduction operations. However, in this case, although the reproduction time is shortened, it is difficult for the user to properly perform the digest reproduction without failing to listen to a characteristic part of the music.

On the other hand, when utilizing recommended functions provided by many music distribution services, the user can learn the music that meets preference of the user to some extent without listening to the music. However, each user has his or her own taste for the music. For example, sometimes the same user has an interest in plural pieces of music having largely different characteristics. Sometimes two users whose tastes are similar have interest in different pieces of music. Therefore, it is difficult that the existing recommended function eliminates a need for the trial listening of the music (or the digest reproduction). There is still a demand for a technique of being able to efficiently produce the version in which the reproduction time of the music is shortened.

For example, Japanese Patent No. 4176893 discloses a technique of automatically shortening the reproduction time of the music. Japanese Patent No. 4176893 proposes that the music is segmented into plural regions on a temporal axis according to a melody configuration (such as an introduction and an ending) of the music, a priority is previously allocated to each region, and the reproduction of the region having the low priority is omitted.

### SUMMARY

However, in the technique proposed by Japanese Patent No. 4176893, because only the region to which the high priority is previously allocated is reproduced in a so-called chunk way, a flow of the music is unnatural at a point of the discontinuous region. Various pieces of music are distributed in a market, and there are music in which a redundant tune is repeated in the high-priority region corresponding to a “hook” and music that has a characteristic portion in the low-priority region. Therefore, it is difficult to reproduce musical characteristics of the original music efficiently in the version in which the reproduction time is shortened only by assigning the priority to each region that is segmented according to the melody configuration.

In light of the foregoing, it is desirable to provide an information processing apparatus, a content data reconfiguring method, and a program in which the reproduction time of content data can be changed without largely losing the characteristics of the original content data compared with the existing technique.

Accordingly, there is disclosed an apparatus for processing content data (i.e., music, text, images, video, etc). The apparatus may include a score calculation unit. The score calculation unit may be configured to receive attribute information indicative of attributes of first content data. Additionally, the score calculation unit may be configured to calculate scores of temporal sections of the first content data, based on temporal positions within the first content data at which the attributes of the first content data change. The apparatus may also include a reconfiguration unit. The reconfiguration unit may be configured to receive the first content data. In addition, the reconfiguration unit may be configured to extract selected ones of the temporal sections from the first content data, based on the scores of the temporal sections. The reconfiguration unit may also be configured to combine the extracted temporal sections to create modified content data.

There is also disclosed a method of processing content data. A processor may execute a program to cause an apparatus to perform the method. The program may be stored on a non-transitory, computer-readable storage medium. The method may include receiving first content data. The method may also include receiving attribute information indicative of attributes of the first content data. In addition, the method may include calculating scores of temporal sections of the first content data, based on temporal positions within the first content data at which the attributes of the first content data change. The method may also include extracting selected ones of the temporal sections from the first content data, based on the scores of the temporal sections. Additionally, the method may include combining the extracted temporal sections to create modified content data.

According to an information processing apparatus, a content data reconfiguring method, and a program of an embodiment, a reproduction time of content data can be changed without largely losing the characteristics of the original content data compared with the existing technique.

### BRIEF DESCRIPTION OF THE DRAWINGS

FIG. 1 is a block diagram illustrating an example of an information processing apparatus according to an embodiment;

FIG. 2 is an explanatory view illustrating an example of an attribute in each bar (i.e., temporal section) of music (i.e., music data) or an attribute in each beat;

FIG. 3 is an explanatory view illustrating an example of data defining a beat position and a bar line position of the music;

FIG. 4 is an explanatory view illustrating an example of metadata expressing an attribute (i.e., attribute information indicative of an attribute) in each bar of music or an attribute in each beat;

FIG. 5 is an explanatory view illustrating an example of a score table in which scores identifying characteristic bars are stored;

FIG. 6 is an explanatory view illustrating score addition in response to a change in melody type;

FIG. 7 is an explanatory view illustrating score addition in response to a change in key;

FIG. 8 is an explanatory view illustrating score addition in response to a change in musical time (i.e., meter);

FIG. 9 is an explanatory view illustrating score addition in response to a change in chord;

FIG. 10 is an explanatory view illustrating score addition in response to a change in instrument type;

FIG. 11 is an explanatory view illustrating score addition in response to a change in existence or non-existence of a singing voice;

FIG. 12 is an explanatory view illustrating score addition in response to a change in volume;

FIG. 13 is an explanatory view illustrating score addition in response to a bar position;

FIG. 14 is an explanatory view illustrating score addition in response to a melody type;

FIG. 15 is an explanatory view illustrating an example of a result of score calculating processing executed by a score calculation unit (i.e., a software module, a hardware module, or a combination of a software module and a hardware module);

FIG. 16A is a first explanatory view illustrating bar extracting processing executed by a reconfiguration unit;

FIG. 16B is a second explanatory view illustrating the bar extracting processing executed by the reconfiguration unit;

FIG. 16C is a third explanatory view illustrating the bar extracting processing executed by the reconfiguration unit;

FIG. 17A is a first half of a flowchart illustrating an example of the bar extracting processing executed by the reconfiguration unit;

FIG. 17B is a second half of a flowchart illustrating the example of the bar extracting processing executed by the reconfiguration unit;

FIG. 18 is a flowchart illustrating another example of the bar extracting processing executed by the reconfiguration unit;

FIG. 19 is a flowchart illustrating an example of music reconfiguring processing according to an embodiment;

FIG. 20 is an explanatory view illustrating an example of bar copying processing executed by the reconfiguration unit; and

FIG. 21 is a flowchart illustrating another example of the music reconfiguring processing of the embodiment.

### DETAILED DESCRIPTION OF THE EMBODIMENTS

Hereinafter, embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

“DETAILED DESCRIPTION OF THE EMBODIMENTS” will be described as follows:

1. Configuration example of information processing apparatus according to an embodiment

2. Flow example of music reconfiguring processing according to an embodiment

3. Application example

4. Conclusion

### 1. CONFIGURATION EXAMPLE OF INFORMATION PROCESSING APPARATUS ACCORDING TO AN EMBODIMENT

For example, an information processing apparatus according to an embodiment may be a PC (Personal Computer), a smart phone, a PDA (Personal Digital Assistant), a music player, a game terminal, and digital home electronics. The information processing apparatus may be a server that executes the following music reconfiguring processing in response to a request transmitted from the above-described devices.

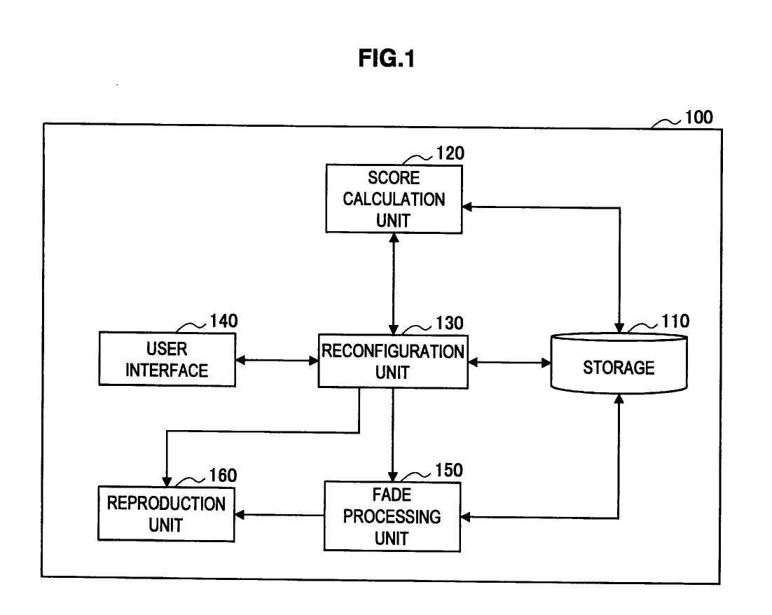

FIG. 1 is a block diagram illustrating an example of an information processing apparatus 100 according to an embodiment. Referring to FIG. 1, the information processing apparatus 100 includes a storage 110 (i.e., a memory), a score calculation unit 120, a reconfiguration unit 130, a user interface 140, a fade processing unit 150, and a reproduction unit 160.

### [1-1. Storage]

The storage 110 stores various pieces of data used in the music reconfiguring processing according to the embodiment using a storage medium such as a hard disk or a semiconductor memory. For example, the storage 110 stores waveform data of music in which a reproduction time should be changed. The waveform data of the music may be coded according to any voice coding method such as WAVE, MP3 (MPEG Audio Layer-3) and AAC (Advanced Audio Coding). The storage unit 110 stores data identifying a beat and a bar line, which are included in the music. Furthermore, according to the embodiment, the storage 110 stores metadata expressing an attribute in each bar of the music or an attribute in each beat included in each bar.

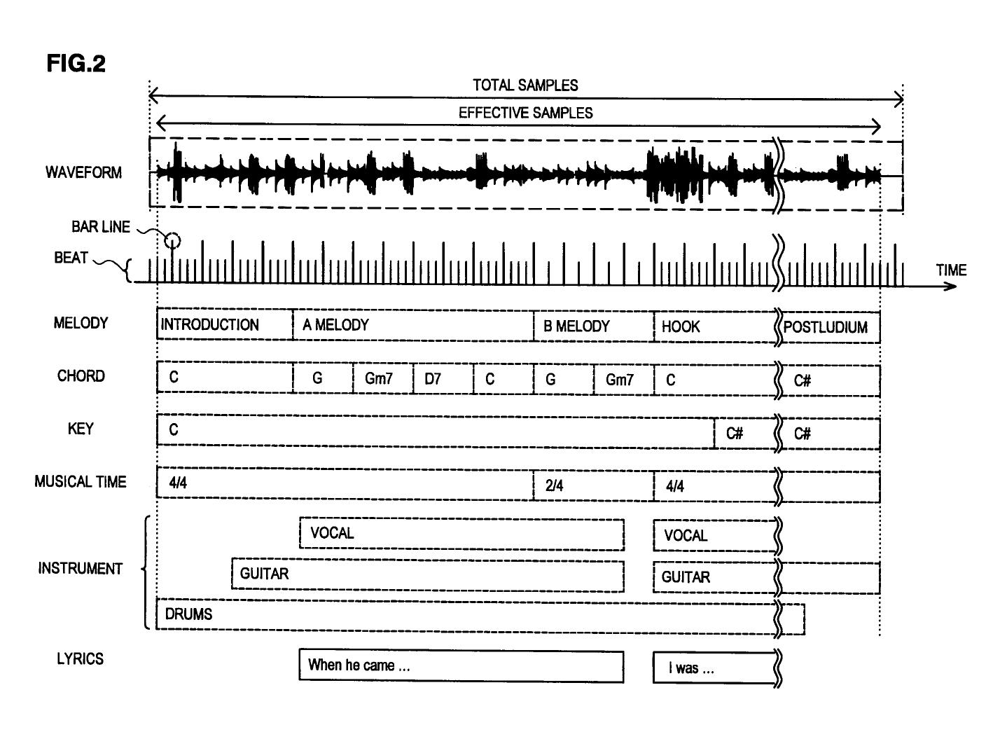

FIG. 2 is an explanatory view illustrating an example of the attribute in each bar of the music or the attribute in each beat. A waveform of certain music along a temporal axis is illustrated in an uppermost part of FIG. 2. The waveform of the music is sampled at a predetermined sampling rate and coded. In one pieces of music, the number of effective samples in which substantial sound (voice waveform) is coded may be lower than the total number of samples.

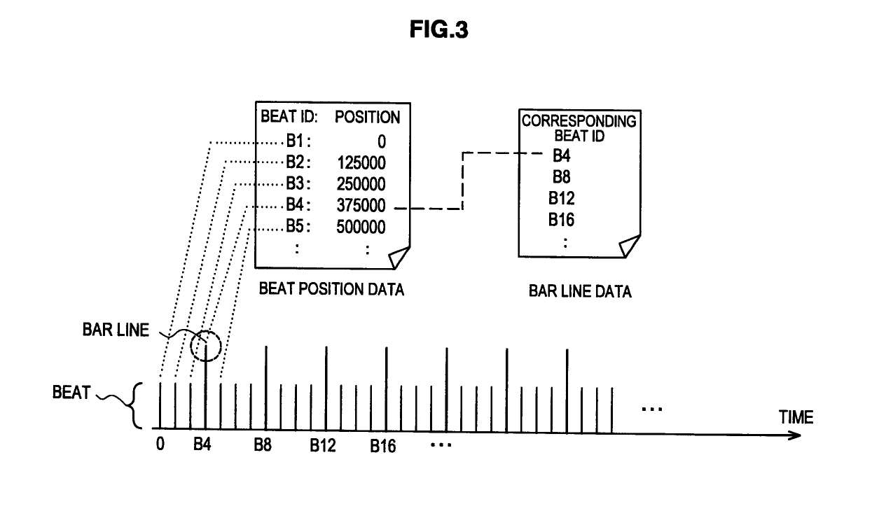

Referring to FIG. 2, below the waveform, a temporal position of the beat and a temporal position of the bar line are plotted on the temporal axis by a short vertical line and a long vertical line, respectively. The beat position and the bar line position may previously and automatically be recognized by analyzing the waveform data of the music according to a technique disclosed in, for example, Japanese Patent Application Laid-Open No. 2007-248895, or the beat position and the bar line position may manually be assigned. FIG. 3 illustrates an example of beat position data defining the beat position and bar line data defining a bar line position (temporal position at a bar starting point) of the music. For example, the beat position data may define a beat ID identifying each of plural beats included in the music and the temporal position of each beat while the beat ID and the temporal position are correlated with each other. In the example of FIG. 3, assuming that an origin is a time point (i.e., a temporal position) the music sampling is started, the temporal position of the beat is expressed by the number of sampling times up to the time point. The temporal position may be expressed by an elapsed time instead of the number of sampling times. In the example of FIG. 3, a position of a beat B1 is zero, a position of a beat B2 is “125000 (samples)”, a position of a beat B3 is “250000 (samples)”, a position of a beat B4 is “375000 (samples)”, and a position of a beat B5 is “500000 (samples)”. For example, the bar line data may be the data that defines the position of the bar line included in the music by assigning the beat ID of one of the beats. In the example of FIG. 3, the positions of the beats B4, B8, B12, B16, and the like are defined as the bar line position of the music.

In a lower part of FIG. 2, a “melody type”, a “chord”, a “key”, a “musical time”, “instrument”, and “lyrics” are illustrated as example of the attribute in each bar of the music (or attribute in each beat included in each bar). The “melody type” expresses a kind of the melody, such as an “introduction”, an “A melody”, a “B melody”, a “hook”, and a “postludium” to which each bar or each beat belongs. The “chord” expresses a chord (such as C, C#, and Cm) that is performed in each bar or each beat. The “key” expressed a key (including a scale) that is performed in each bar or each beat. The “musical time” expresses a musical time (such as four-four time and two-four time) that is performed in each bar or each beat. The “instrument” expresses a kind of an instrument that is performed in each bar or each beat. As illustrated in FIG. 3, a vocal (singing voice) may be dealt with as one kind of the instrument in addition to the usual instruments such as a guitar and drums. The attribute may previously and automatically be recognized by analyzing the waveform data of the music according to a technique disclosed in, for example, Japanese Patent Application Laid-Open No. 2010-122629. Instead, a user who listens to the music to determine the attribute may manually provide the attribute to the music.

For example, the metadata expressing the attribute may directly correlate the beat ID included in the beat position data illustrated in FIG. 3 with an attribute value such as the melody type, the chord, the key, the musical time, the instrument, and the existence or non-existence of singing voice. Instead, the metadata may indirectly correlate the bars or beats thereof with the attribute through the temporal axis by assigning the temporal position at which each attribute value emerges with progression of the music.

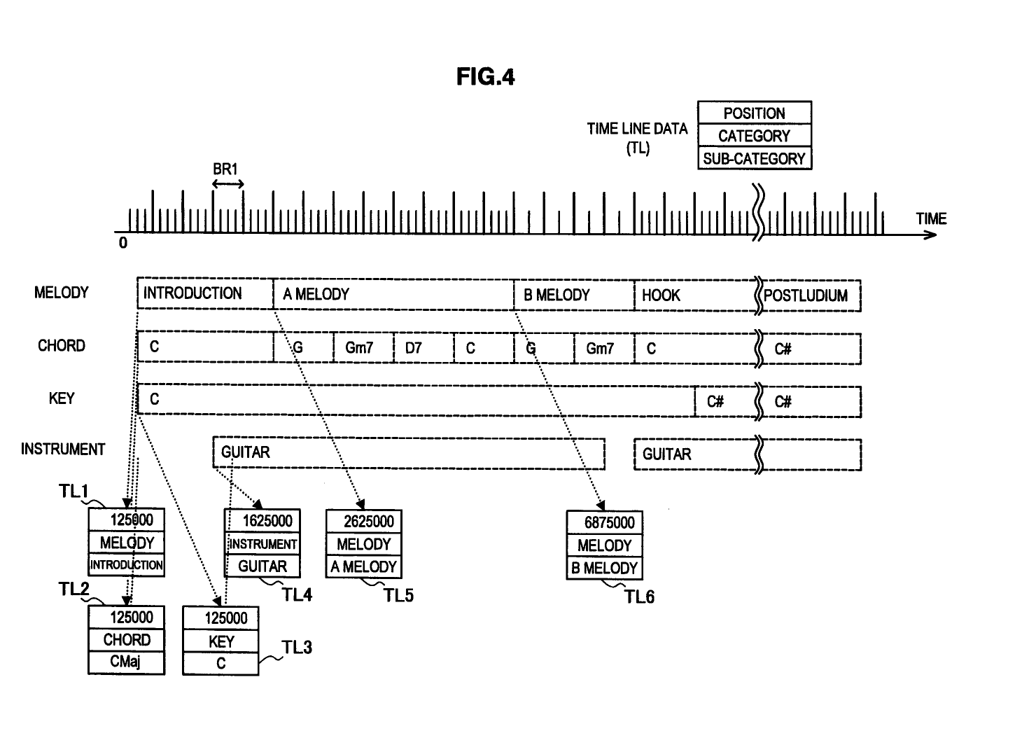

FIG. 4 is an explanatory view illustrating an example of the metadata stored in the storage 110. Referring to FIG. 4, time line data that indirectly correlates the bars or beats thereof with the attribute through the temporal axis is illustrated as an example of the metadata. The time line data includes three data items, namely, a “position”, a “category”, and a “sub-category”. For example, the “position” specifies the temporal position with progression of the music using the number of sampling times (or the elapsed time) in which the time point the music sampling is started is set to the origin. The “category” and the “sub-category” express attributes corresponding to the temporal position specified by the “position” or a period starting from the temporal position. More specifically, when the “category” is the “melody”, the kind of melody (that is, the melody type) that is currently performed is expressed by the “sub-category”. When the “category” is the “chord”, the kind of chord that is currently performed is expressed by the “sub-category”. When the “category” is the “key”, the kind of key that is currently performed is expressed by the “sub-category”. When the “category” is the “instrument”, the kind of instrument that is currently performed is expressed by the “sub-category”.

In the example of FIG. 4, for example, the melody type of each of the bars (each beat) from 125000 samples to 2625000 samples is found to be the “introduction” from pieces of data TL1 to TL5 included in the metadata. The melody type of each of the bars (each beat) from 2625000 samples to 6875000 samples is found to be the “A melody” from pieces of data TL5 and TL6. Similarly, for example, a bar BR1 that is of the firth bar is found to have attributes such as the melody type of the “introduction”, the chord of “C”, the key “C”, and the instrument of the “guitar” from pieces of data such as TL1, TL2, TL3, and TL4.

The storage 110 previously stores the waveform data, the beat position data, the bar line data, and the metadata while correlating the waveform data, the beat position data, the bar line data, and the metadata with an identifier (music ID) and a title of each piece of music. The storage 110 may store lyrics data that correlates a text in which each phrase included in the lyrics of the music is described with the temporal position at which the phrase is sung. The storage 110 also stores the score table and bar extraction table which are used in the score calculation unit 120 and the reconfiguration unit 130.

### [1-2. Score Calculator]

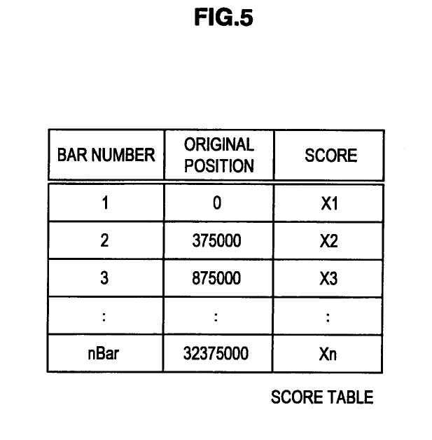

According to the above metadata, the score calculation unit 120 calculates a score in each bar of the music to identify characteristic bars from the viewpoint of a sense for music. As used herein, the characteristic bars include bars before and after a time point when an attribute of bar or an attribute of beat changes in the music. For example, the score calculation unit 120 stores the score in each bar calculated based on the metadata in the score table illustrated in FIG. 5.

FIG. 5 is an explanatory view illustrating an example of the score table in which a score calculated by the score calculation unit 120 is stored. Referring to FIG. 5, the score table includes three data items, namely, a “bar number”, an “original position”, and a “score”. The “bar number” is provided in temporal order to each bar of the music. The “original position” expresses the temporal position of the starting point of each bar in the music of pre-reconfiguration (hereinafter referred to as original music). The “score” expresses one that is calculated with respect to each bar by the score calculation unit 120.

In advance to score calculating processing, based on the beat position data and the bar line data of FIG. 3, the score calculation unit 120 initializes the corresponding “score” to zero while registering the “bar number” and the “original position” in the score table. Then, based on the attribute in each bar of the music or the attribute in each beat, which are expressed by the metadata, the score calculation unit 120 identifies the characteristic bar from the viewpoint of the sense for music according to the following way of thinking, and adds a predetermined value to the score of each identified bar. In FIG. 5, the sign nBar designates the maximum bar number in the music.

### (1) Change in Melody Type

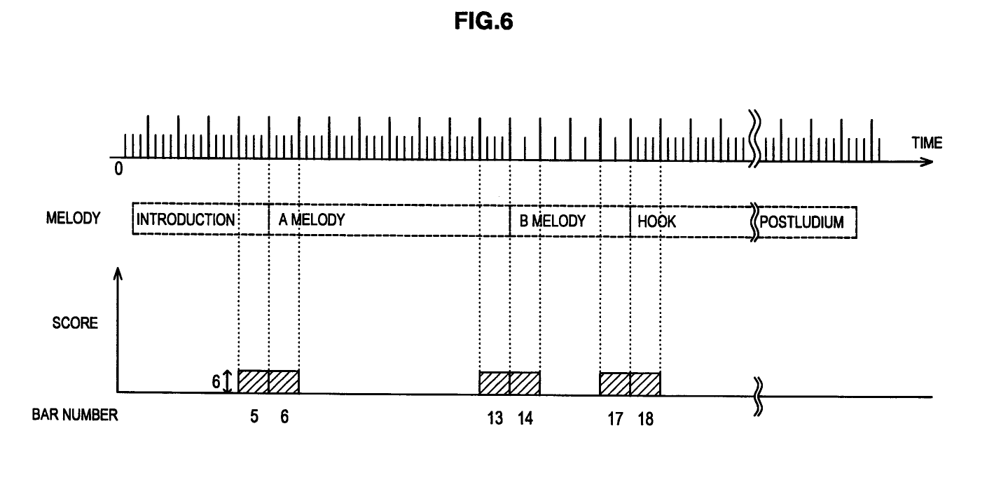

For example, the score calculation unit 120 may identify bars before and after a time point the melody type changes as characteristic bars. FIG. 6 is an explanatory view illustrating the score addition in response to the change in melody type. Referring to FIG. 6, the melody type expressed by the metadata is illustrated along the temporal axis. In the example of FIG. 6, during a fifth bar and a sixth bar (i.e., at a temporal position defining a boundary between the fifth bar and the sixth bar), the melody type changes from the “introduction” to the “A melody”. During a thirteenth bar and a fourteenth bar, the melody type changes from the “A melody” to the “B melody”. During a seventeenth bar and an eighteenth bar, the melody type changes from the “B melody” to the “hook”. Accordingly, the fifth, sixth, thirteenth, fourteenth, seventeenth, and eighteenth bars may be identified as the characteristic bars before and after the time point the melody type changes. Therefore, the score calculation unit 120 adds a predetermined value (6 in the example of FIG. 6) to the scores of the bars.

At this point the value of 6 is added only by way of example, and another value may be added to the score. In the example of FIG. 6, the score calculation unit 120 adds the value of 6 only to the scores of the two bars immediately before and immediately after the time point the melody type changes. However, the score calculation unit 120 may add the predetermined value to the scores of the plural bars before the time point the melody type changes and to the scores of the plural bars after the time point the melody type changes. The value added to the score may be decreased with increasing temporal distance from the time point the melody type changes. The same holds true for the score addition in response to the changes in other attributes described below.

The value larger than that of other bars may be added to the score with respect to the bar in which the corresponding change in melody type corresponds to a specific pattern. For example, the specific pattern may be a pattern from the “A melody” to the “hook” or a pattern from the “B melody” to the “hook”.

### (2) Change in Key

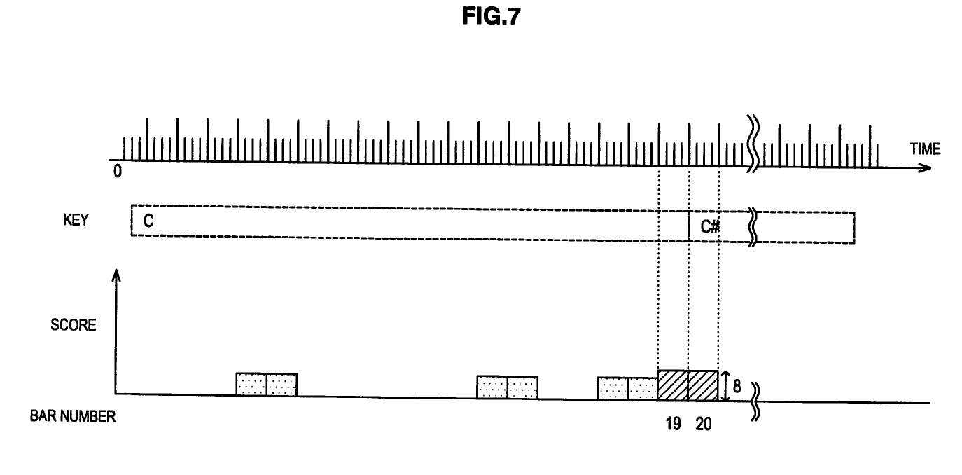

For example, the score calculation unit 120 may identify the bars before and after the time point the key (or scale) changes as the characteristic bars. FIG. 7 is an explanatory view illustrating the score addition in response to the change in key. Referring to FIG. 7, the key expressed by the metadata is illustrated along the temporal axis. In the example of FIG. 7, during a nineteenth bar and a twentieth bar, the key changes from the “C” to the “C#”. Accordingly, the nineteenth and twentieth bars may be identified as the characteristic bars before and after the time point the key changes. Therefore, the score calculation unit 120 adds a predetermined value (8 in the example of FIG. 7) to the scores of the bars.

### (3) Change in Musical Time

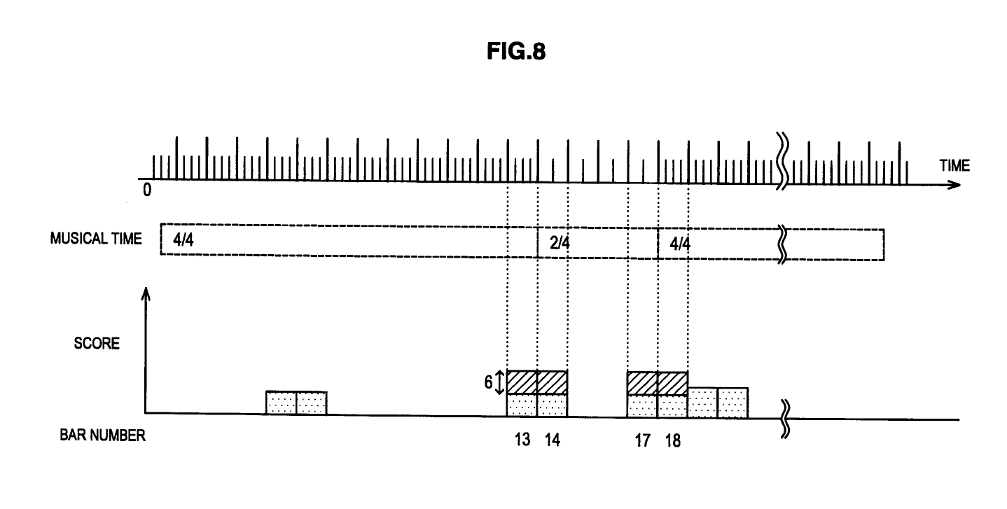

For example, the score calculation unit 120 may identify the bars before and after the time point the musical time changes as the characteristic bars. FIG. 8 is an explanatory view illustrating the score addition in response to the change in musical time. Referring to FIG. 8, the musical time expressed by the metadata is illustrated along the temporal axis. In the example of FIG. 8, during the thirteenth bar and the fourteenth bar, the musical time changes from the “four-four” to the “two-four”. During the seventeenth bar and the eighteenth bar, the musical time changes from the “two-four” to the “four-four”. Accordingly, the thirteenth, fourteenth, seventeenth, and eighteenth bars may be identified as the characteristic bars before and after the time point the musical time changes. Therefore, the score calculation unit 120 adds a predetermined value (6 in the example of FIG. 8) to the scores of the bars.

### (4) Change in Chord

For example, the score calculation unit 120 may identify the bars before and after the time point the change in patter having a relatively low occurrence frequency occurs in the time point the chord changes as the characteristic bars. Generally a period during which one chord is continued in the music is one beat in the shortest and several bars at the longest. Accordingly, even if the chord changes, the point at which the change in pattern occurs is not the characteristic point when the change in pattern (combination of chords before and after the change) has the high occurrence frequency. On the other hand, the point at which the change in pattern has the low occurrence frequency may be the characteristic point. Accordingly, in the embodiment, the score calculation unit 120 makes up the occurrence frequency of the change in pattern of the chord based on the metadata relating to the chord, and the score calculation unit 120 identifies the bars before and after the time point the change in pattern having the relatively low occurrence frequency occurs as the characteristic bars.

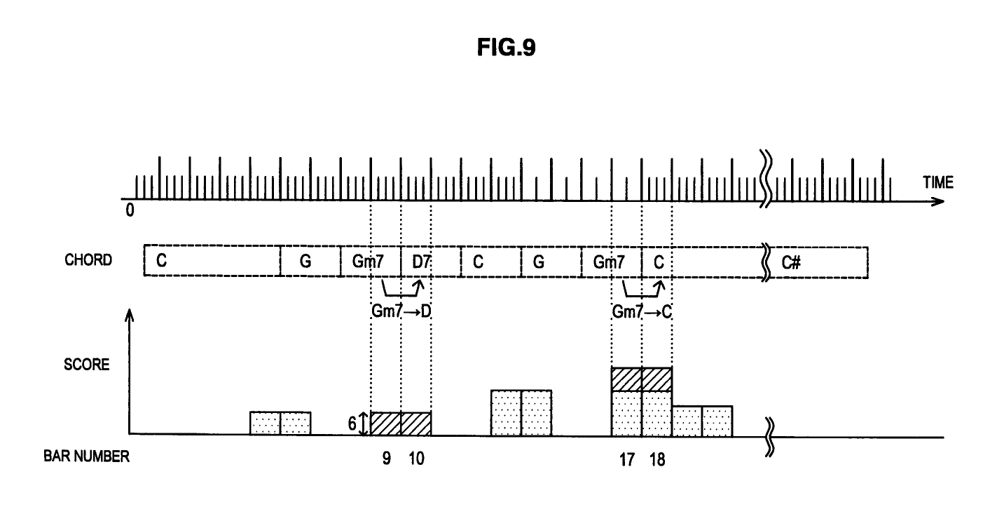

FIG. 9 is an explanatory view illustrating the score addition in response to the change in chord. Referring to FIG. 9, the chord expressed by the metadata is illustrated along the temporal axis. In the example of FIG. 9, for example, chord progression from “C” to “G” occurs twice. The chord progression from “G” to “Gm7” also occurs twice. On the other hand, during the ninth bar and the tenth bar, the chord progression from “Gm7” to “D7” occurs only once. During the seventeenth bar and the eighteenth bar, the chord progression from “Gm7” to “C” also occurs only once. Therefore, the score calculation unit 120 adds a predetermined value (6 in the example of FIG. 9) to the scores of the ninth, tenth, seventeenth, and eighteenth bars. For example, different additional values (for example, the value that is increased with decreasing occurrence frequency) may be used according to the occurrence frequency of the corresponding chord progression.

The score calculation unit 120 may make up the occurrence frequency of the change in pattern of the chord in not each two bars but each three bars (or more).

### (5) Change in Instrument

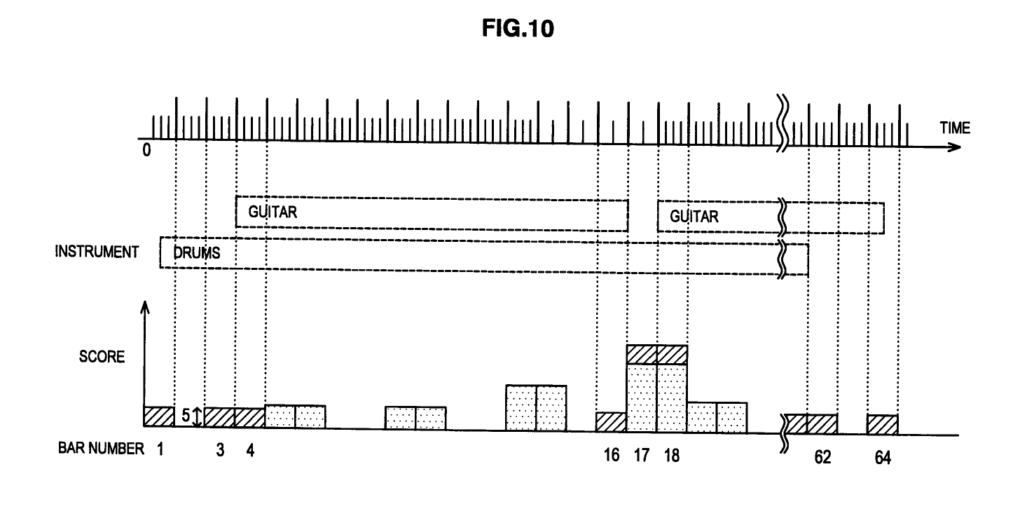

For example, the score calculation unit 120 may identify the bars before and after the time point the kind of the currently-performed instrument changes as the characteristic bars. FIG. 10 is an explanatory view illustrating the score addition in response to the change in instrument type. Referring to FIG. 10, the kind of the currently-performed instrument expressed by the metadata is illustrated along the temporal axis. In the example of FIG. 10, in the first bar, the performance of the “drums” is started. During the third bar and the fourth bar, the performance of the “guitar” is started. During the sixteenth bar and the seventeenth bar, the performance of the “guitar” is interrupted and resumed. During the sixty-first bar and the sixth-second bar, the performance of the “drums” is ended. In the sixty-fourth bar, the performance of the “guitar” is ended. Accordingly, the first, third, fourth, sixteenth, seventeenth, eighteenth, sixty-first, sixty-second, and sixty-fourth bars may be identified as the characteristic bars before and after the time point the kind of the instrument changes. Therefore, the score calculation unit 120 adds a predetermined value (5 in the example of FIG. 10) to the scores of the bars. For example, different additional values may be used according to the corresponding kind of the instrument.

### (6) Change in Existence or Non-Existence of Singing Voice

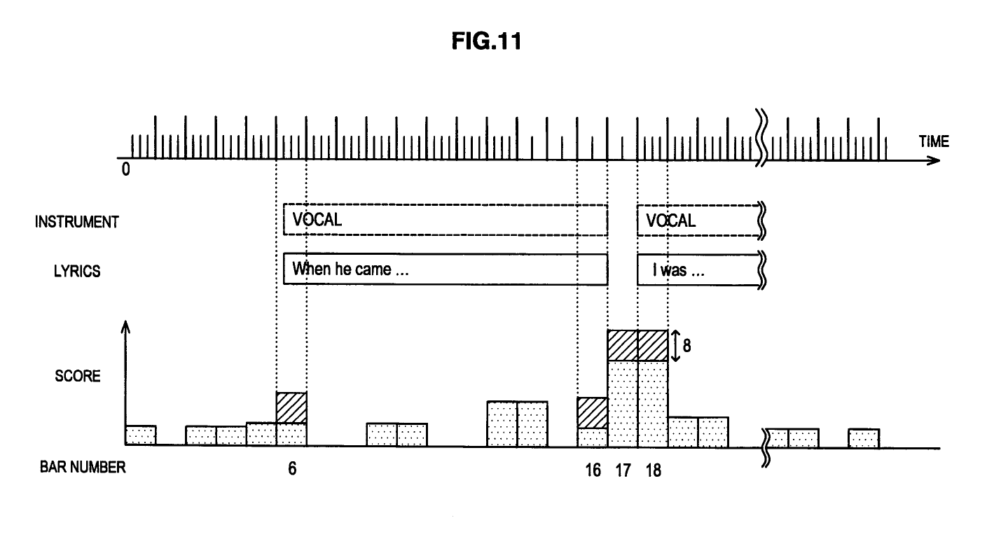

For example, the score calculation unit 120 may identify the bars before and after the time point the existence or non-existence of the singing voice changes as the characteristic bars. FIG. 11 is an explanatory view illustrating the score addition in response to the change in existence or non-existence of the singing voice. Referring to FIG. 11, the existence or non-existence of the singing voice expressed by the metadata relating to the “instrument” is illustrated along the temporal axis. FIG. 11 additionally illustrates the existence or non-existence of the singing voice expressed by the lyrics data. The existence or non-existence of the singing voice may be determined based on one of the pieces of data. In the example of FIG. 11, in the sixth bar, phonation of the singing voice is started. During the sixteenth bar to the eighteenth bar, the phonation is interrupted and resumed. Accordingly, the sixth, sixteenth, seventeenth, and eighteenth bars may be identified as the characteristic bars before and after the time point the existence or non-existence of the singing voice changes. Therefore, the score calculation unit 120 adds a predetermined value (8 in the example of FIG. 11) to the scores of the bars.

### (7) Change in Volume

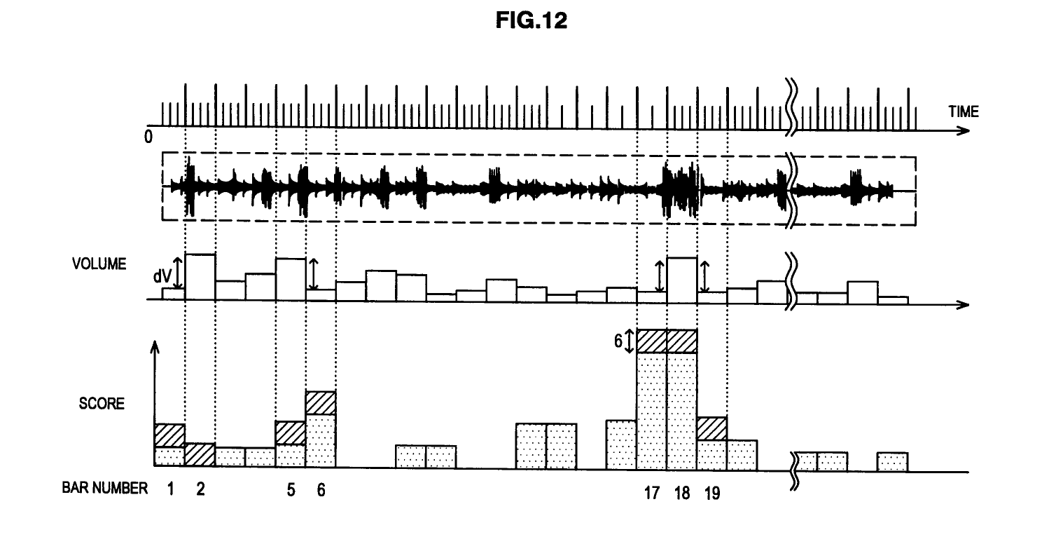

For example, the score calculation unit 120 may identify the bars before and after the time point a volume changes while exceeding a predetermined amount of change as the characteristic bars. FIG. 12 is an explanatory view illustrating the score addition in response to the change in volume. Referring to FIG. 12, the volume is calculated in each bar as an average value of strength of waveform energy over one bar. In the example of FIG. 12, the volume change while exceeding a predetermined amount of change dV during the first bar and second bar, the fifth bar and the sixth bar, the sixteenth bar and the seventeenth bar, and the seventeenth bar and the eighteenth bar. Accordingly, the first, second, fifth, sixth, sixteenth, seventeenth, and eighteenth bars may be identified as the characteristic bars. Therefore, the score calculation unit 120 adds a predetermined value (6 in the example of FIG. 12) to the scores of the bars.

### (8) Bar Position

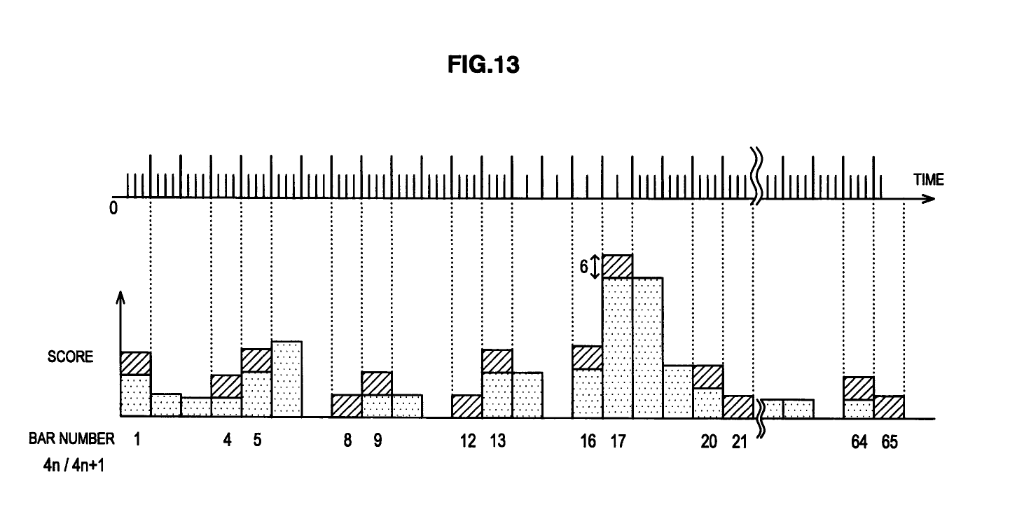

For example, the score calculation unit 120 may adjust the score in each bar by further adding a value to the score of the bar at a specific position. The specific position may be a 4 nth bar and a (4n+1)th bar or an 8 nth bar and an (8n+1)th bar, where n is an integer of 0 or more. This is based on the fact that frequently the similar melody is repeated in units of 4 bars or 8 bars in the music. FIG. 13 is an explanatory view illustrating the score addition in response to the bar position. In the example of FIG. 13, the 4 nth bar and the (4n+1)th bar are identified as the characteristic bar, and a predetermined value (6 in the example of FIG. 13) is added to the scores of the bar.

### (9) Attribute Type

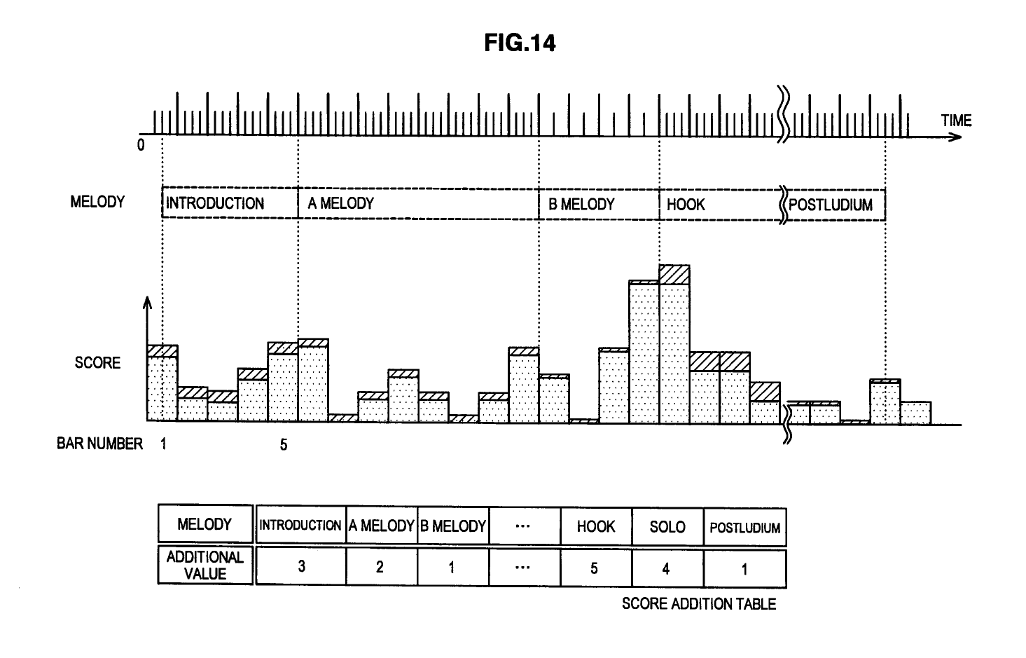

For example, the score calculation unit 120 may adjust the score in each bar by adding an additional value to the score of the bar having a specific kind of attribute. For example, the specific kind may be one of the melody types or one of the kinds of the instruments. FIG. 14 is an explanatory view illustrating the score addition in response to the melody type. Referring to FIG. 14, an score addition table defining the additional value of the score in each melody type is illustrated. In the score addition table of FIG. 14, for example, 3 is the additional value for the “introduction”. Therefore, the score calculation unit 120 adds the additional value of 3 to the scores of the first to fifth bars in which the melody type is the “introduction”. Similarly, the score calculation unit 120 adds the value defined by the score addition table to the scores of other bars. The additional value corresponding to the kind of the attribute may previously be defined as a fixed value. For example as illustrated in the example of FIG. 14, the additional value for the “hook” may be defined larger than other melody type.

For example, in the case in which the same melody type occurs plural times in the music, the different additional values may be applied according to the occurrence point. For example, the additional value for the final “hook” in the “hooks” may be larger than the additional values of the “hooks” at other positions. For example, the additional value for the initial “A melody” in the “A melodies” may be larger than the additional values of the “A melodies” at other positions.

The additional value corresponding to the kind of the attribute may be defined in each user. For example, for the user who prefers the specific kind of the instrument (for example, the “guitar” or the “vocal”), the additional value corresponding to the specific kind of the instrument is defined larger, which allows the user to individually obtain the reconfigured music having different contents even if the reproduction times are identical.

### (10) Example of Result of Score Calculating Processing

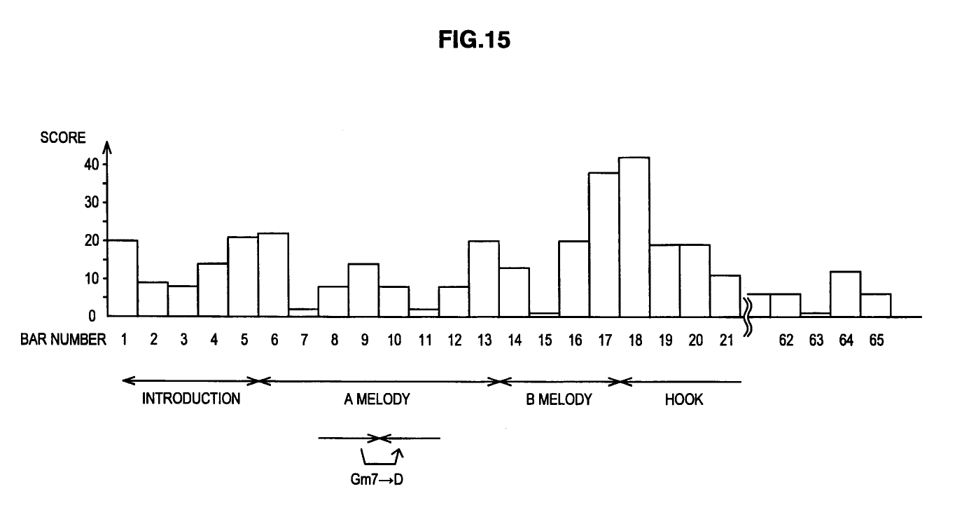

The score calculation unit 120 calculates the score in each bar of the music and stores the calculated score in the score table according to at least one of the above-described way of thinking. FIG. 15 is an explanatory view illustrating an example of a result of the score calculating processing executed by the score calculation unit 120. Referring to FIG. 15, a graph of the score calculating result is illustrated. In FIG. 15, a horizontal axis is the bar number and a vertical axis is the calculated score. As can be seen from the graph of FIG. 15, the score is low in the period during which the attribute does not change in each bar, and the score is high before and after the time point the attribute changes. For example, in the period from the sixth bar to the thirteenth bar, the score of the sixth bar corresponding to the time point the “A melody” is started and the score of the thirteenth bar corresponding to the time point the “A melody” is ended are relatively higher than the score of the bar in the middle of the “A melody”. In the bars belonging to the “A melody”, the scores of the bars before and after the ninth bar are higher than the scores of other bars. This is because the chord changes before and after the ninth bar.

### [1-3. Reconfigurator]

The reconfiguration unit 130 extracts the bar having the relatively high score calculated by the score calculation unit 120 from the original music, thereby reconfiguring the music having the duration different from that of the original music. For example, the reconfiguration unit 130 may extract the bar having the score exceeding an assigned threshold from the original music. The reconfiguration unit 130 stores information on the extracted bar in a bar extraction table.

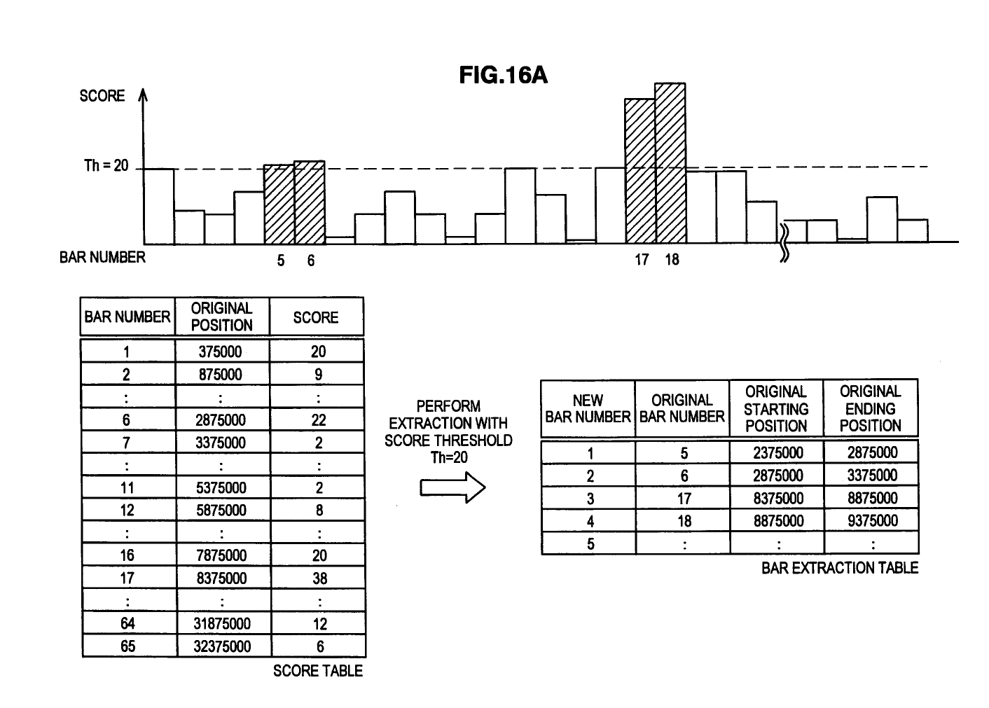

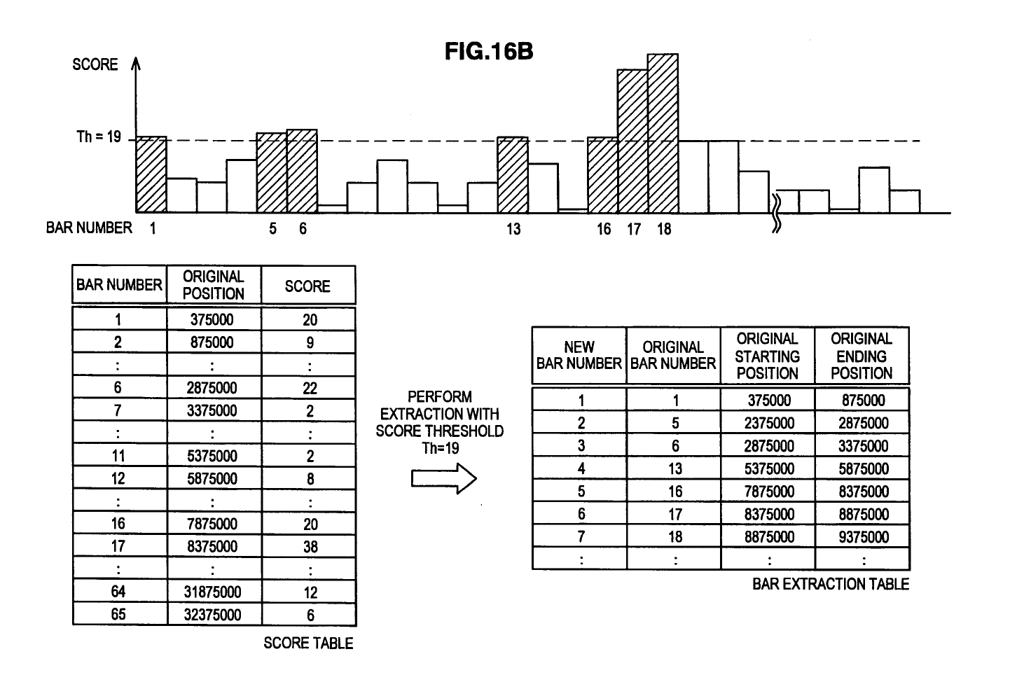

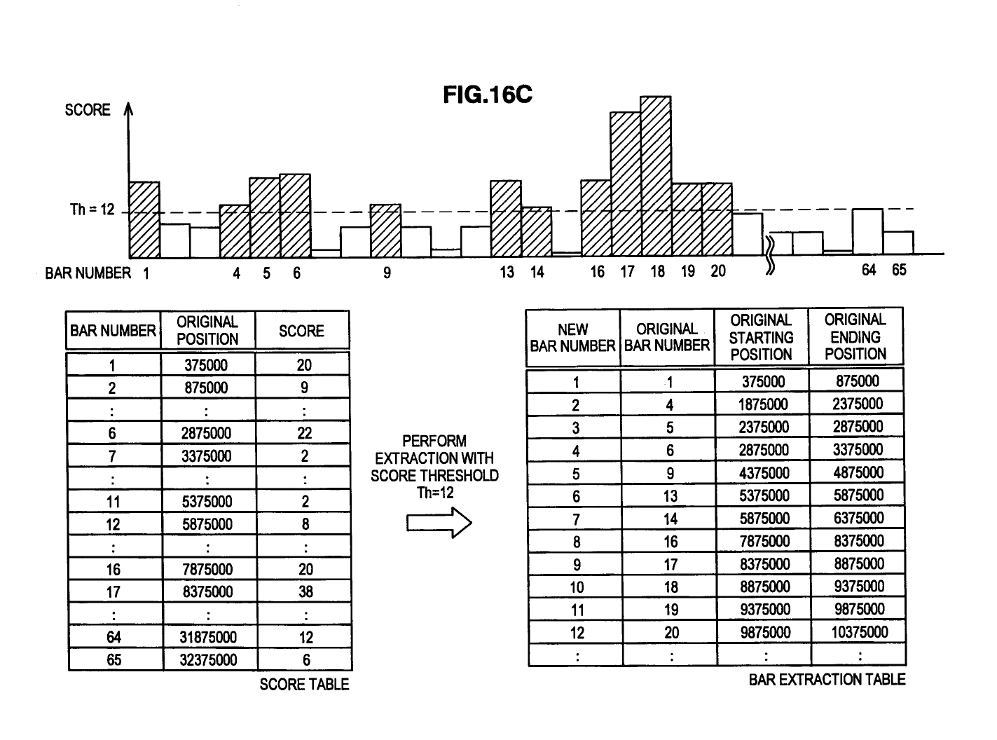

FIGS. 16A to 16C are explanatory views illustrating the bar extracting processing executed by the reconfiguration unit 130. The graph of the score in each bar, which is illustrated in FIG. 15 by way of example, is illustrated in each upper part of FIGS. 16A to 16C. A hatching region expresses that the score of the hatched bar exceeds a corresponding threshold of each drawing. An example of contents of the score table after the score calculating processing is illustrated in each lower-left part of FIGS. 16A to 16C. An example of the bar extraction table generated by bar extracting processing executed by the reconfiguration unit 130 is illustrated in each lower-right part of FIGS. 16A to 16C. For example, referring to FIG. 16A, the bar extraction table includes four data items, namely, a “new bar number”, an “original bar number”, an “original starting position”, and an “original ending position”. The “new bar number” is provided in temporal order to each bar of the music that is reconfigured as a result of the bar extracting processing. The “original bar number” is a bar number in the original music of the bar. The “original starting position” expresses the temporal position of the starting point of the bar in the original music. The “original ending position” expresses the temporal position of the ending point of the bar in the original music.

In the example of FIG. 16A, 20 is a threshold Th used to extract the bar. At this point, the fifth, sixth, seventeenth, and eighteenth bars in the original music (i.e., the first content data) are extracted as the first, second, third, and fourth bars in the reconfigured music (i.e., the modified content data). In the example of FIG. 16B, 19 is the threshold Th used to extract the bar. At this point, the first, fifth, sixth, thirteenth, sixteenth, seventeenth, and eighteenth bars in the original music are extracted as the first to seventh bars in the reconfigured music. In the example of FIG. 16C, 12 is the threshold Th used to extract the bar. At this point, the first, fourth, fifth, sixth, ninth, thirteenth, fourteenth, sixteenth, seventeenth, eighteenth, nineteenth, and twentieth bars in the original music are extracted as the first to twelfth bars in the reconfigured music.

Thus, the number of extracted bar is increasing with decreasing threshold Th, and therefore the reproduction time of the reconfigured music is lengthened with decreasing threshold Th. The threshold Th may be assigned (i.e., input) by the user. Alternatively, the information processing apparatus 100 causes the user to assign (i.e., input) the reproduction time of the reconfigured music, and the information processing apparatus 100 may dynamically adjust the threshold Th such that the assigned reproduction time is achieved.

### (1) First Scenario

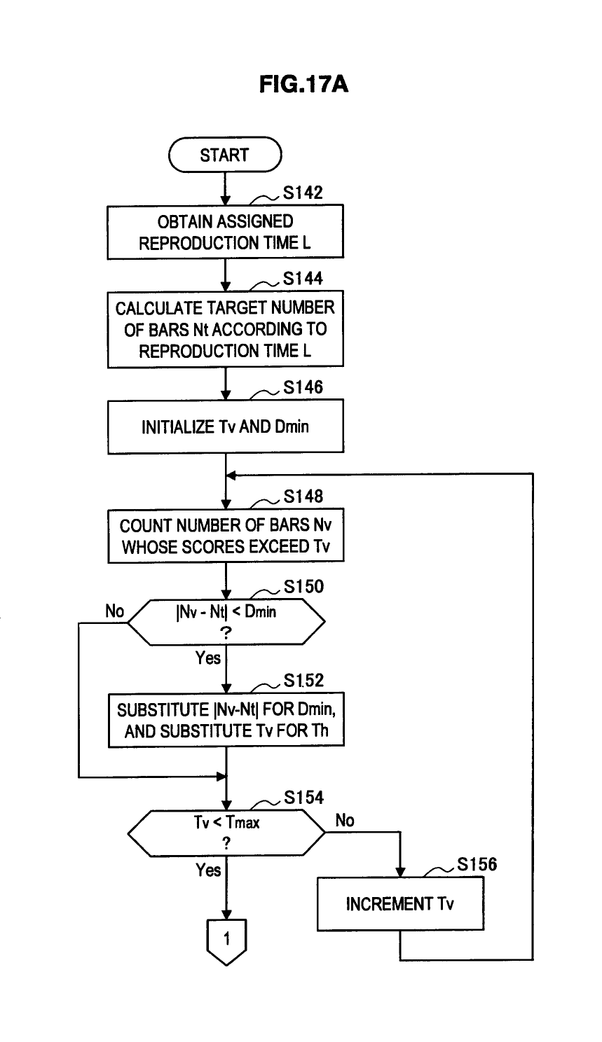

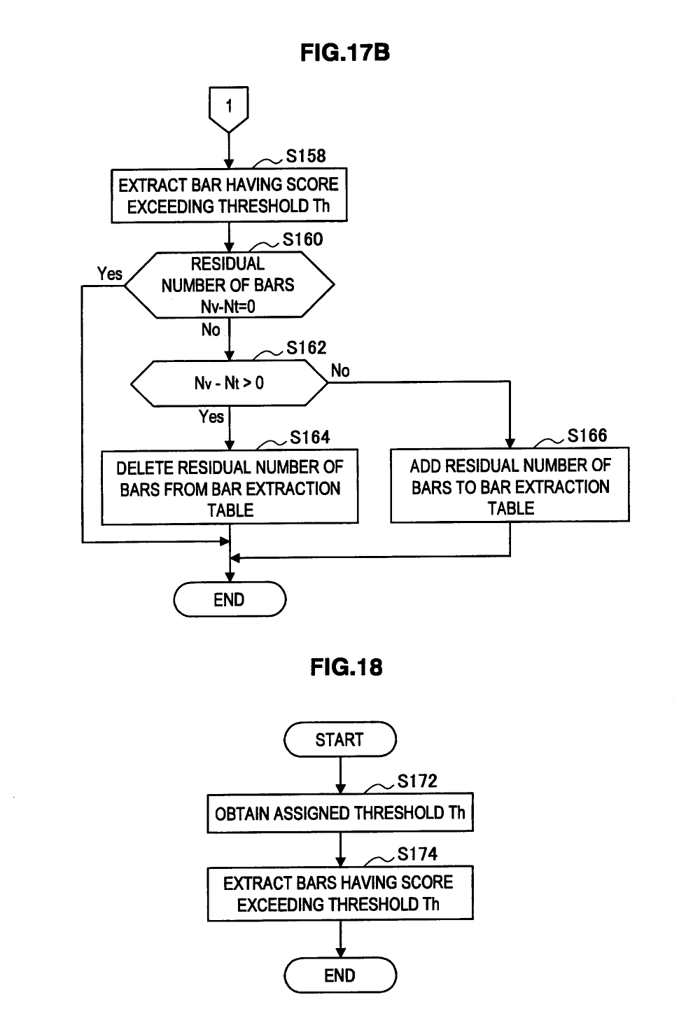

FIGS. 17A and 17B are a flowchart illustrating an example of the bar extracting processing executed by the reconfiguration unit 130. The flowchart of FIGS. 17A and 17B is one that is based on a scenario in which the reproduction time of the reconfigured music is assigned by the user.

Referring to FIG. 17A, the reconfiguration unit 130 obtains a reproduction time L assigned by the user (Step S142). The reconfiguration unit 130 calculates the target number of bars Nₜ that is of a target of the number of bars to be extracted from the original music according to the obtained reproduction time L (Step S144). Assuming that BPM (Beat Per Minute) is a tempo (the number of beats per minute) of the music and METER (for example, 4 in the case of four-four, and 2 in the case two-four) is a main musical time of the music, the target number of bars Nₜ may be calculated according to the following equation (1).

$$\begin{matrix}[ Formula 1 ] & \\ {N}_{t} = \frac{L \times BPM}{METER \times 60} & ( 1 )\end{matrix}$$

A length L_{BAR} of one bar may be calculated according to the following equation (2).

$$\begin{matrix}[ Formula 2 ] & \\ {L}_{BAR} = \frac{METER \times 60}{BPM} & ( 2 )\end{matrix}$$

Then the reconfiguration unit 130 initializes variables Tᵥ and Dₘᵢₙ (Step S146). The variable Tᵥ retains a tentative threshold. For example, the initial value of the variable Tᵥ is set to zero. The variable Dₘᵢₙ retains a difference between the target number of bars Nₜ and the number of tentatively-extracted bars. For example, the initial value of the variable Dₘᵢₙ in may be a value that sufficiently exceeds the number of bars of the original music.

The reconfiguration unit 130 counts the number of bars Nᵥ in which the score exceeds Tᵥ (Step S148). The reconfiguration unit 130 determines whether an absolute value |Nᵥ−Nₜ| of the difference between the number of counted bars Nᵥ and the target number of bars Nₜ is lower than Dₘᵢₙ (Step S150). When |Nᵥ−Nₜ| is lower than Dₘᵢₙ, the reconfiguration unit 130 substitutes Tᵥ for the threshold Th while substituting |Nᵥ−Nₜ| for Dₘᵢₙ (Step S152). When |Nᵥ−Nₜ| is not lower than Dₘᵢₙ, processing in Step S152 is skipped.

The reconfiguration unit 130 determines whether Tᵥ is lower than a predetermined maximum value Tₘₐₓ (Step S154). For example, the maximum value Tₘₐₓ may be a maximum value in the scores stored in the score table. When Tᵥ is lower than Tₘₐₓ, the reconfiguration unit 130 increments Tᵥ (for example, adds 1) (Step S156). The flow returns to Step S148. On the other hand, when Tᵥ is not lower than Tₘₐₓ, the flow goes to Step S158 of FIG. 17B.

The reconfiguration unit 130 extracts bars having the score exceeding the threshold Th from the original music (Step S158). As a result, the bar extraction tables of FIGS. 16A to 16C are formed. Then the reconfiguration unit 130 estimates a residual number Nᵥ−Nₜ between the number of extracted bars Nᵥ and the target number of bars Nₜ (Steps S160 and S162).

When the residual number Nᵥ−Nₜ is equal to zero, the bar extracting processing executed by the reconfiguration unit 130 is ended.

When the residual number Nᵥ−Nₜ is more than zero, the reconfiguration unit 130 deletes the number of bars corresponding to the residual number Nᵥ−Nₜ (Step S164). For example, the reconfiguration unit 130 may delete the bar that is selected in the order of increasing score. For example, when the plural bars including scores that should be deleted and that are equal to one another are present, the reconfiguration unit 130 may delete the bar located in a front (or rear) part of the array or the randomly-selected bar.

When the residual number Nᵥ−Nₜ is lower than zero, the reconfiguration unit 130 adds the number of bars corresponding to the residual number Nᵥ−Nₜ to the bar extraction table (Step S166). For example, the reconfiguration unit 130 may add the bar that is selected in the order of decreasing score in the unextracted bars. For example, when the plural bars including scores that should be added and that are equal to one another are present, the reconfiguration unit 130 may add the bar located in the front (or rear) part of the array or the randomly-selected bar.

### (2) Second Scenario

FIG. 18 is a flowchart illustrating another example of the bar extracting processing executed by the reconfiguration unit 130. The flowchart of FIG. 18 is one that is based on a scenario in which the threshold Th used to extract the bar is assigned by the user.

Referring to FIG. 18, the reconfiguration unit 130 obtains the threshold Th assigned by the user (Step S172). The reconfiguration unit 130 extracts the bar having the score exceeding the threshold Th from the original music (Step S174). As a result, the bar extraction tables of FIGS. 16A to 16C are formed.

### [1-4. User Interface]

The user interface 140 provides a user interface for the music reconfiguring processing executed by the information processing apparatus 100 to the user. For example, the user interface 140 may display a screen that causes the user to assign the reproduction time L of the reconfigured music on a display (or a display of another apparatus that conduct communication with the information processing apparatus 100) connected to the information processing apparatus 100. The user interface 140 may display a screen that causes the user to assign the threshold Th. The music of the reconfiguration target may also be assigned by the user through the screen.

The user interface 140 may provide display (for example, the graphs illustrated in FIGS. 16A to 16C) in which the extracted bar can be ensured on the screen to the user in response to the assignment of the reproduction time L or the threshold Th.

For example, the user interface 140 may provide a setting screen that causes the user to set the additional value of the score according to various attributes in the score adding processing of FIGS. 6 to 14 to the user.

### [1-5. Fade Processor]

The fade processing unit 150 applies the cross-fade to the first and second bars, which are discontinuous before the extraction and continuous after the extraction, in the bars extracted from the music by the reconfiguration unit 130.

For example, when the reconfiguration unit 130 extracts the bars from the music, the fade processing unit 150 cuts out the waveforms of the bars registered in the bar extraction table from the waveform data in the order of the new bar number. When the original bar numbers of the two bars successively cut out are discontinuous, the fade processing unit 150 fades in a head of the subsequent bar while fading out a tail end of the prior bar. The fade processing unit 150 may store the sequence of waveforms of the reconfigured music that is obtained and processed in the above-described way in the storage 110.

Alternatively, in reproducing the music, the fade processing unit 150 may obtain the waveform data of the original music from the storage 110 and remix the music in real time according to the data registered in the bar extraction table. Even in this case, the fade processing unit 150 may apply the cross-fade to the two bars in which the original bar numbers are discontinuous. For example, Japanese Patent Application Laid-Open No. 2008-164932 discloses a technique of remixing the music in real time from the waveform data of the original music to reproduce the music.

The fade processing unit 150 may change the durations of the fade-in and fade-out, namely, fade duration in the cross-fade depending on a type of chord in the case where the two bars overlap each other. For example, the fade processing unit 150 determines which of consonance and dissonance is generated in overlapping the first bar and the second bar using the metadata relating to the chords of the two bars. The fade processing unit 150 uses the long fade time when the consonance is generated, and the fade processing unit 150 uses the short fade time when the dissonance is generated.

### [1-6. Reproducer]

The reproduction unit 160 reproduces the reconfigured music that is extracted from the original music by the reconfiguration unit 130 and processed by the fade processing unit 150. At this point, when the reproduction time L assigned by the user is not an integral multiple of the length L_{BAR} of the bar that may be calculated according to the equation (2), there is a possibility that the duration of the reconfigured music is not exactly matched with the reproduction time L. Therefore, the reproduction unit 160 may finely adjust the tempo of the music in reproducing the music such that the duration of the reproduced music is matched with the reproduction time L.

### 2. FLOW EXAMPLE OF MUSIC RECONFIGURING PROCESSING ACCORDING TO AN EMBODIMENT

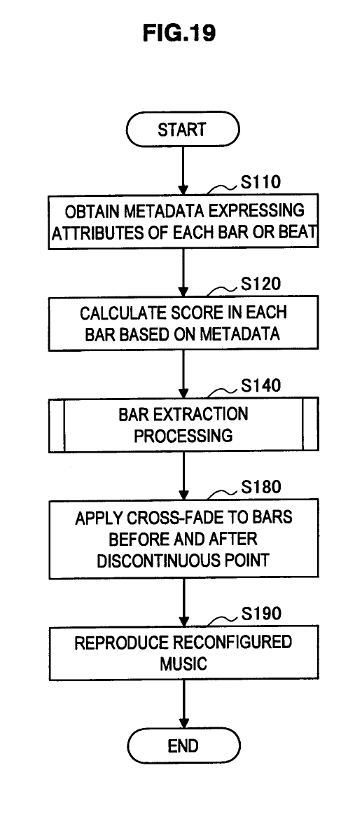

FIG. 19 is a flowchart illustrating an example of music reconfiguring processing executed by the information processing apparatus 100 of the embodiment.

Referring to FIG. 19, the score calculation unit 120 obtains the metadata expressing attributes in each bar of the music or attributes in each beat included in each bar from the storage 110 (Step S110). The score calculation unit 120 calculates the score, which identifies the characteristic bar including the bars before and after the time point the attribute of the melody type changes, in each bar based on the obtained metadata (Step S120). The reconfiguration unit 130 executes the bar extracting processing of FIGS. 17A, 17B, and 18 to reconfigure the music having the duration different from that of the original music (Step S140). The fade processing unit 150 applies the cross-fade to the bars before and after the discontinuous point of the original bar number in the extracted bars (Step S180). The reproduction unit 160 reproduces the reconfigured music in which the reproduction time is shortened (Step S190).

### 3. APPLICATION EXAMPLE

In the music reconfiguring processing, the reproduction time of the reconfigured music is shorter than the reproduction time of the original music. However, as described in this section, the music reconfiguring processing can also be applied to extension of the reproduction time of the music.

For example, when the reproduction time L longer than the reproduction time of the original music is assigned, the reconfiguration unit 130 copies the plural bars selected in units of melodies in the original music. For example, the position at which the bar is copied may be the position at which the change in pattern of the melody type that occurs in the original music is repeated or other position.

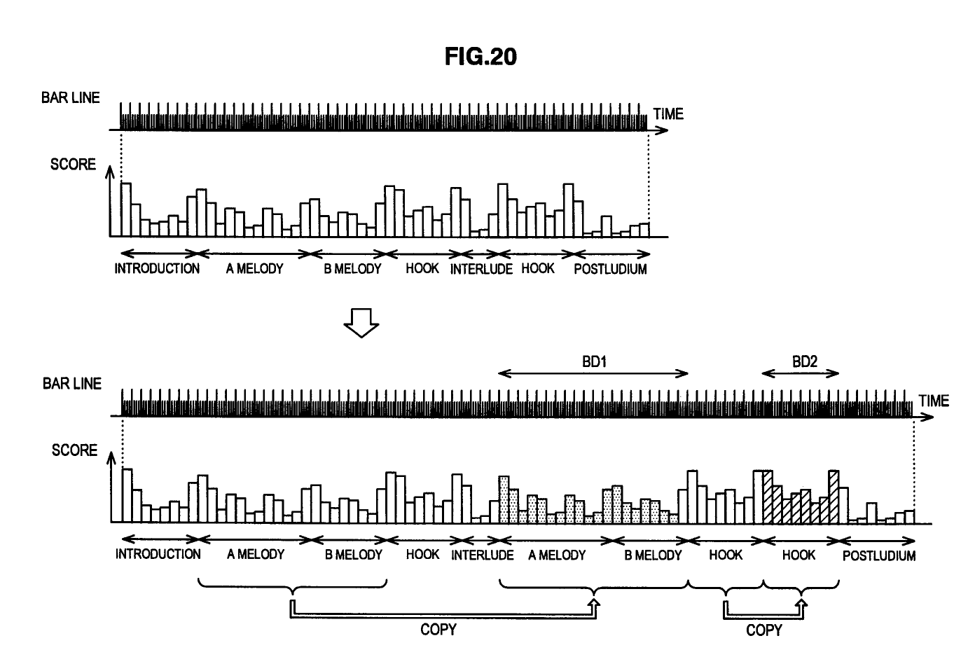

FIG. 20 is an explanatory view illustrating an example of bar extracting processing executed by the reconfiguration unit 130 according to an application example. In an upper part of FIG. 20, the bar line of the original music, the score calculated in each bar, and the melody type of each bar are illustrated along the temporal axis. On the other hand, the state in which the bar of part of the original music is copied is illustrated in the lower part of FIG. 20. For example, the bars in an interval BD1 after the copy are the copies of the bars belonging to the “A melody” and the “B melody” of the original music. The pattern of “A melody”→“B melody”→“hook” is repeated by the copy in the changes in patterns of the melody type, which occur in the original music. The bars in an interval BD2 after the copy are the copies of the bars belonging to the second “hook” in the original music.

The reconfiguration unit 130 determines the number of copied bars such that the duration of the copied music is sufficiently longer than the reproduction time L. After copying the plural bars, the reconfiguration unit 130 extracts the bar having the relatively high score such that the duration of the reconfigured music is equal to the reproduction time L (or at least brought close to the reproduction time L) according to the bar extracting processing of FIGS. 17A and 17B.

Thus, the bar is not simply added to the original music such that the duration of the reconfigured music is equal to the reproduction time L, but the bar extracting processing is applied based on the score after the plural bars are copied in units of melodies to sufficiently extend the duration of the music, whereby the sense for music of the original music may better be reproduced even in the reconfigured music.

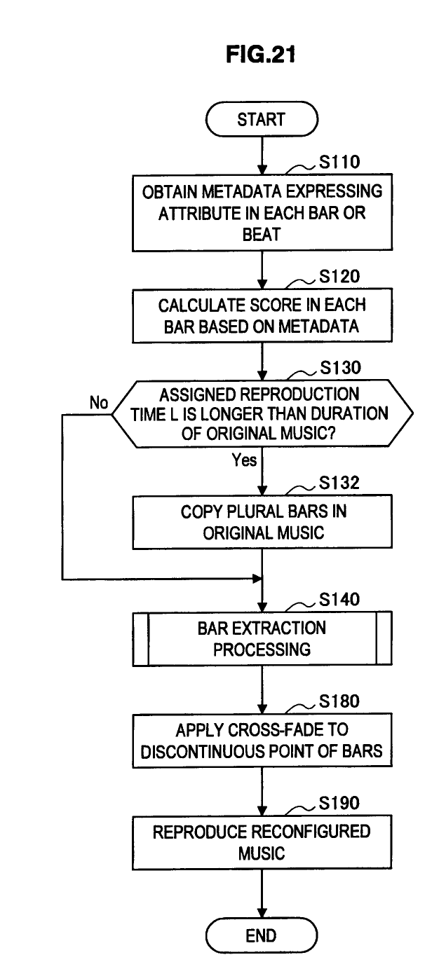

FIG. 21 is a flowchart illustrating another example of the music reconfiguring processing of the application example.

Referring to FIG. 21, the score calculation unit 120 obtains the metadata expressing attributes in each bar of the music or attributes in each beat included in each bar from the storage 110 (Step S110). The score calculation unit 120 calculates the score, for example, which identifies the characteristic bar including the bars before and after the time point the attribute of the melody type changes, in each bar based on the obtained metadata (Step S120).

The reconfiguration unit 130 determines whether the reproduction time L of the music assigned through the user interface 140 is longer than the duration of the original music (Step S130). When the reproduction time L is longer than the duration of the original music, the reconfiguration unit 130 copies the plural bars in the original music as described above with reference to FIG. 20 (Step S132). On the other hand, when the reproduction time L is not longer than the duration of the original music, the processing in Step S132 is skipped.

The reconfiguration unit 130 executes the bar extracting processing of FIGS. 17A, 17B to reconfigure the music having the duration different from that of the original music (Step S140). The fade processing unit 150 applies the cross-fade to the bars before and after the discontinuous point of the original bar number in the extracted bars (Step S180). The reproduction unit 160 reproduces the reconfigured music in which the reproduction time is changed (Step S190).

### 4. CONCLUSION

The embodiment is described above with reference to FIGS. 1 to 21. According to the embodiment, the score identifying the characteristic bar including the bars before and after the time point the attribute changes is calculated based on the metadata expressing the attribute in each bar of the music or the attribute in each beat included in each bar, and the bars having the relatively high scores are extracted from the music. The music having the duration different from that of the original music is reconfigured from the extracted bars. According to the configuration, while the bars, in the period during which, for example, the same melody types, the same chords, and the same keys are continued, namely in the period during which the musical characteristic of the music is substantially maintained, are omitted, the bars at the head and the tail end are preferentially left in the reconfigured music. Accordingly, when the reproduction time of the music is shortened by the reconfiguration, parts having the different musical characteristics are rarely reproduced in the chunk way, but the natural flow of the music can be maintained.

The bars before and after the time point the musical characteristic changes are preferentially left in the reconfigured music, whereby various musical characteristics included in one music are reproduced at least on a piecemeal basis even after the reproduction time is shortened. Therefore, the user can efficiently listen to various musical characteristics of the music. As a result, the purchase by the user can effectively be promoted. Also, this enables the user to find the music that meets preference of the user from the large amount of music easier.

According to the embodiment, because the music is reconfigured in units of bars, a beat sense, the tempo, and the rhythm of the music are not broken up by the reconfiguration.

According to the embodiment, the score that is the reference for extracting the bar is calculated based on various musical characteristics such as the change in melody type, the change in key or scale, the change in musical time, the change in chord, the change in instrument that is currently performed, the change in existence or non-existence of the singing voice, and the change in volume. These references for calculating the score may arbitrarily be combined. The different calculation reference may be utilized by each user. That is, the reconfigured versions having different contents can be provided according to the purpose of the service, the kind of the usable data, the preference of the user, and the like.

According to the embodiment, the natural flow of the reconfigured music may be strengthened by applying the cross-fade to the two bars discontinuous in the original music.

According to the embodiment, when the duration of the music is extended, after the plural bars selected in units of melodies are copied, the bar having the relatively high score is extracted, and the music is reconfigured so as to be matched with the assigned duration. The position at which the plural bars are copied may be the position at which the change in pattern of the kind of the melody is repeated. Therefore, the musical characteristic of the music can more naturally be reproduced in the reconfigured music.

The sequence of pieces of processing executed by the information processing apparatus described in the embodiment may be achieved by one of software, hardware, and a combination of the software and the hardware. For example, the program constituting the software is previously stored in the storage medium (i.e., the non-transitory, computer-readable storage medium) that is provided in or out of each apparatus. Each program, for example, is read in RAM (Random Access Memory) during the execution, and executed by a processor such as a CPU (Central Processing Unit).

It should be understood by those skilled in the art that various modifications, combinations, sub-combinations and alterations may occur depending on design requirements and other factors insofar as they are within the scope of the appended claims or the equivalents thereof.

What is claimed is:

1. An apparatus for processing content data, comprising:
a score calculation unit configured to:
receive attribute information indicative of attributes of first content data; and
calculate scores of temporal sections of the first content data, based on temporal positions within the first content data at which the attributes of the first content data change; and
a reconfiguration unit configured to:
receive the first content data;
extract selected ones of the temporal sections from the first content data, based on the scores of the temporal sections; and
combine the extracted temporal sections to create modified content data.

2. The apparatus of claim 1, comprising a memory, wherein:
the score calculation unit is configured to receive the attribute information from the memory; and
the reconfiguration unit is configured to receive the first content data from the memory.

3. The apparatus of claim 1, wherein the score calculation unit is configured to calculate a score of a temporal section of the first content data, based on a temporal position within the first content data at which an attribute of the first content data changes, the temporal position being within the temporal section.

4. The apparatus of claim 1, wherein the score calculation unit is configured to calculate a score of a temporal section of the first content data, based on a temporal position within the first content data at which an attribute of the first content data changes, the temporal position being temporally before or temporally after the temporal section.

5. The apparatus of claim 1, wherein the score calculation unit is configured to calculate a score of a temporal section of the first content data, based on a temporal position within the first content data at which an attribute of the first content data changes, the temporal position defining a boundary between a first temporal section and a second temporal section.

6. The apparatus of claim 1, wherein the score calculation unit is configured to calculate a score of a temporal section of the first content data, based on a temporal position within the first content data at which a melody of the first content data changes.

7. The apparatus of claim 1, wherein the score calculation unit is configured to:
receive attribute information indicative of attributes of first music data; and
calculate a score of a temporal section of the first music data, based on a temporal position within the first music data at which a key of the first music data changes.

8. The apparatus of claim 1, wherein the score calculation unit is configured to:
receive attribute information indicative of attributes of first music data; and
calculate a score of a temporal section of the first music data, based on a temporal position within the first music data at which a meter of the first music data changes.

9. The apparatus of claim 1, wherein the score calculation unit is configured to:
receive attribute information indicative of attributes of first music data; and
calculate a score of a temporal section of the first music data, based on a temporal position within the first music data at which a chord of the first music data changes.

10. The apparatus of claim 1, wherein the score calculation unit is configured to calculate a score of a temporal section of the first content data, based on a temporal position of the temporal section.

11. The apparatus of claim 1, wherein the score calculation unit is configured to calculate a score of a temporal section of the first content data, based on an attribute of the temporal section.

12. The apparatus of claim 1, wherein the score calculation unit is configured to calculate a score of a temporal section of the first content data, based on a temporal distance between the temporal section and a temporal position within the first content data at which an attribute of the first content data changes.

13. The apparatus of claim 1, wherein the reconfiguration unit is configured to extract from the first content data temporal sections having scores exceeding a threshold score.

14. The apparatus of claim 13, comprising a user interface configured to receive a user input of the threshold score.

15. The apparatus of claim 13, comprising a user interface configured to receive a user input of a reproduction time for the modified content data, wherein the reconfiguration unit is configured to determine the threshold score, based on the reproduction time.

17. The apparatus of claim 1, comprising a fade processing unit, wherein:
the reconfiguration unit is configured to combine the extracted temporal sections in an overlapping fashion to create the modified content data; and
the fade processing unit is configured to fade out a first one of the extracted temporal sections and fade in a second one of the extracted temporal sections to create the modified content data.

18. A method of processing content data, comprising:
receiving first content data;
receiving attribute information indicative of attributes of the first content data;
calculating scores of temporal sections of the first content data, based on temporal positions within the first content data at which the attributes of the first content data change;
extracting selected ones of the temporal sections from the first content data, based on the scores of the temporal sections; and
combining the extracted temporal sections to create modified content data.

19. A non-transitory, computer-readable storage medium storing a program that, when executed by a processor, causes an apparatus to perform a method of processing content data, the method comprising:
receiving first content data;
receiving attribute information indicative of attributes of the first content data;
calculating scores of temporal sections of the first content data, based on temporal positions within the first content data at which the attributes of the first content data change;
extracting selected ones of the temporal sections from the first content data, based on the scores of the temporal sections; and
combining the extracted temporal sections to create modified content data.
